(19) United States
(12) Patent Application Publication
(10) Pub. No.: US 2026/0024114 A1
(43) Pub. Date: Jan. 22, 2026

(54) PREDICTING USER BEHAVIOR FROM AN INITIAL CONVERSION EVENT

(71) Applicant: Maplebear Inc., San Francisco, CA (US)

(72) Inventors: Rustin Partow, San Francisco, CA (US); Yimei Chen, San Jose, CA (US); Qian Liu, Redwood City, CA (US); Eric Guffey, Mountain View, CA (US); Steven Ji, Somerville, MA (US); Feifei Crouch, Charlotte, NC (US)

(21) Appl. No.: 18/775,446

(22) Filed: Jul. 17, 2024

(51) Int. Cl. G06Q 30/0273; G06N 20/20; G06Q 30/0202; G06Q 30/0204

(52) U.S. Cl. CPC G06Q 30/0275; G06N 20/20; G06Q 30/0202; G06Q 30/0205

(57) ABSTRACT

An online concierge system generates the value for an impression by predicting future behavior by users beyond a current conversion. The predicted future behavior attributes incremental value of subsequent conversions by the user. The online concierge system gathers feature information about the user. Based on experimental data, the online concierge system generates a baseline curve describing expected user behavior for a category of users. Based on feature information of the user, the online concierge system applies a computer model to generate modifiers for the baseline curve to customize the baseline curve for the user. The modified curve is used to predict future actions by the user, and consequently a long-term incremental conversion value for the impression.

### BACKGROUND

This disclosure relates generally to predicting behavior for users of online systems, and more specifically to predicting future conversions by users of online systems.

When orders are placed on an online concierge system, the orders may be attributed to an impression of an item of content shown to users. Conventionally, attribution models link individual conversions to one or more past impressions, and often entirely to just the most recent impression. In these models, impressions are typically valued only on the single conversion event. However, these attribution models fail to account for future conversions which would not have occurred without the initial conversion. Without accounting for these future conversions, the true value of the initial conversion, and consequently of the impression to which it is attributed, may be underestimated. But there is currently no technical mechanism for predicting future conversions that are related to an observed conversion.

### SUMMARY

An online concierge system determines the value for an impression (i.e., a last-touch impression before a current conversion) by predicting future behavior beyond the current conversion. The predicted future behavior is used to predict the incremental value of the subsequent sequence of user behavior rather than the current action alone.

When an initial conversion occurs from an impression, the online concierge system may gather feature information about the user and the conversion that may be used alongside experimental data from other users of the online concierge system to predict future actions by the user. The online concierge system generates a baseline curve describing an expected long-term incremental conversion value for a category of users. Based on the feature information of the user, the online concierge system generates modifiers for the baseline curve to customize the baseline curve for this user. The modifiers may be output by a computer model trained on experimental data from other users of the online concierge system and may adjust the baseline curve to better fit feature information of the user. By modifying the baseline curve with the user feature-specific modifiers, the online concierge system generates a modified long-term incremental conversion value for the user that better represents predicted future actions by the user.

Because baseline curves are generated based on experimental data and then further modified based on feature information describing specific users, predictions of users' long-term incremental conversion value produced by this method more accurately represent future actions by users.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is an example timeline illustrating one or more conversion events that may be attributed to a single impression, in accordance with one or more embodiments.

FIG. 4 is an example graph illustrating baseline curves for predicting user behavior based on user types, in accordance with one or more embodiments.

FIG. 5A is an example chart illustrating user feature information for training a computer model for predicting user behavior, in accordance with one or more embodiments.

FIG. 5B is a graph illustrating modifiers applied to a baseline curve, in accordance with one or more embodiments.

FIG. 6 is a flowchart for a method of predicting user behavior based on a conversion event, in accordance with one or more embodiments.

### DETAILED DESCRIPTION

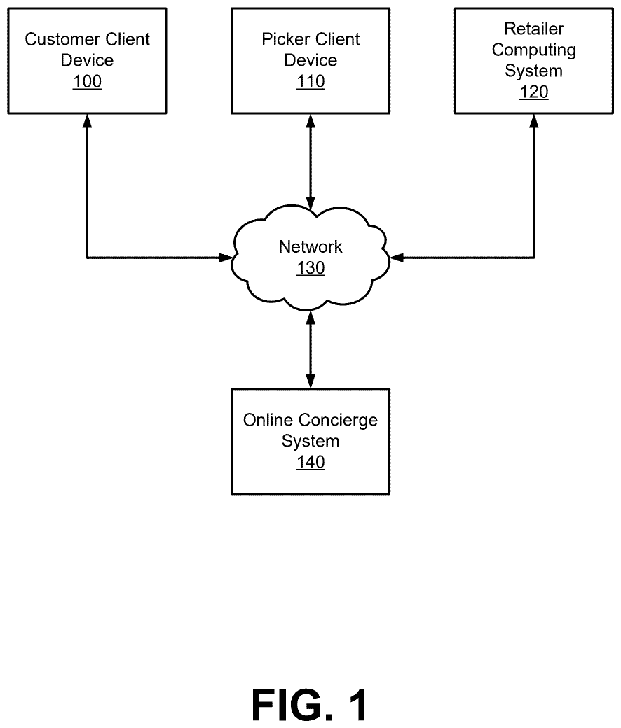

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit (SKU) or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

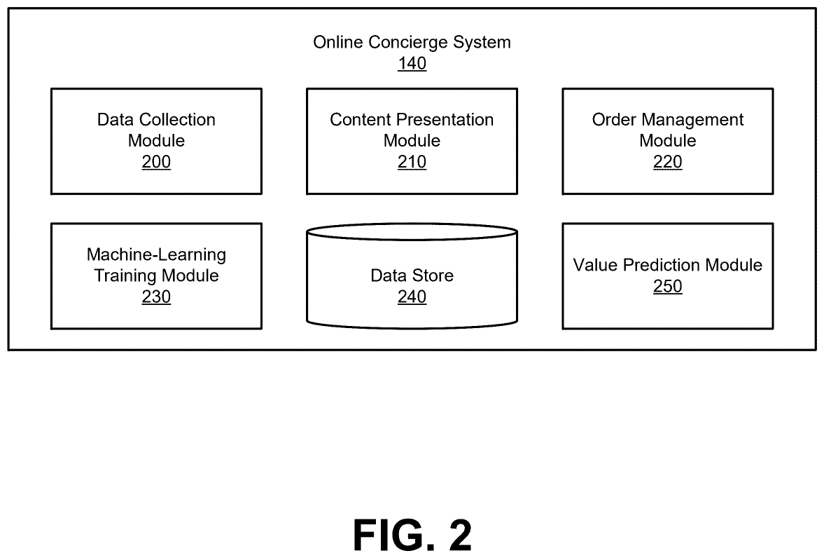

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, a data store 240, and a value prediction module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of the order. In some embodiments, the order management module 220 computes an estimated time of arrival of the picker to the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, hierarchical clustering, and neural networks. Additional examples also include perceptrons, multilayer perceptrons (MLP), convolutional neural networks, recurrent neural networks, sequence-to-sequence models, generative adversarial networks, and transformers. A machine-learning model may include components relating to these different general categories of model, which may be sequenced, layered, or otherwise combined in various configurations.

Each machine-learning model includes a set of parameters. The set of parameters for a machine-learning model are used to process an input and generate an output. For example, a set of parameters for a linear regression model may include weights that are applied to each input variable in the linear combination that comprises the linear regression model. Similarly, the set of parameters for a neural network may include the respective weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes a set of input data for which machine-learning model generates an output. For example, each training example may include customer data, picker data, item data, or order data. In some cases, the training examples also include a label which represents an expected output (i.e., a desired or intended output) of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model, whereby the machine-learning training module 230 updates parameters of the machine-learning model based on each of the set of training examples. The training examples may be processed together, individually, or in batches. To train a machine-learning model based on a training example, the machine-learning training module 230 applies the machine-learning model to the input data in the training example to generate an output with a current set of parameters. The machine-learning training module 230 scores the output from the machine-learning model using a loss function. A loss function is a function that generates a score for the output of the machine-learning model, such that the score is higher when the machine-learning model performs poorly and lower when the machine learning model performs well. In cases where the training example includes a label, the loss function is also based on the label for the training example. Example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory computer-readable media. The data store 240 uses computer-readable media to store data, and may use databases to organize the stored data.

The value prediction module 250 determines values for impressions by predicting future behavior by users beyond a current or initial conversion. Impression values may be described by a number of metrics representing a revenue or profit generated by the associated advertisement content being presented to users of the online concierge system 140 or other third-party systems. Once determined, impression values may be used by the online concierge system 140 or other third-party systems to determine effective or more profitable advertisement content or campaigns in downstream processes, such as which advertisement content to display, which advertisement campaigns to pursue, and/or how much to pay or bid for advertisement content to be displayed.

In many conventional systems, impressions may be valued based on a conversion generated directly by the impression, e.g., the value of an order placed on the online concierge system 140 after a user selects or clicks through a displayed advertisement. However, impression value is more accurately measured by considering longer-term effects of the impression and considering further future conversions that would not have occurred if not for the impression. For example, a user may place a first order with the online concierge system 140 after clicking on a displayed impression. At a later time, the user may return to the online concierge system 140, even without an additional impression, and place another order. Because these other orders are unlikely to have occurred without the initial impression, the value of these other orders should be attributed to the initial impression to determine a long-term incremental conversion value for the impression. The systems discussed herein provides an effective way for predicting the occurrence and value of these later speculative conversions that may otherwise be difficult to effectively model by a computing system.

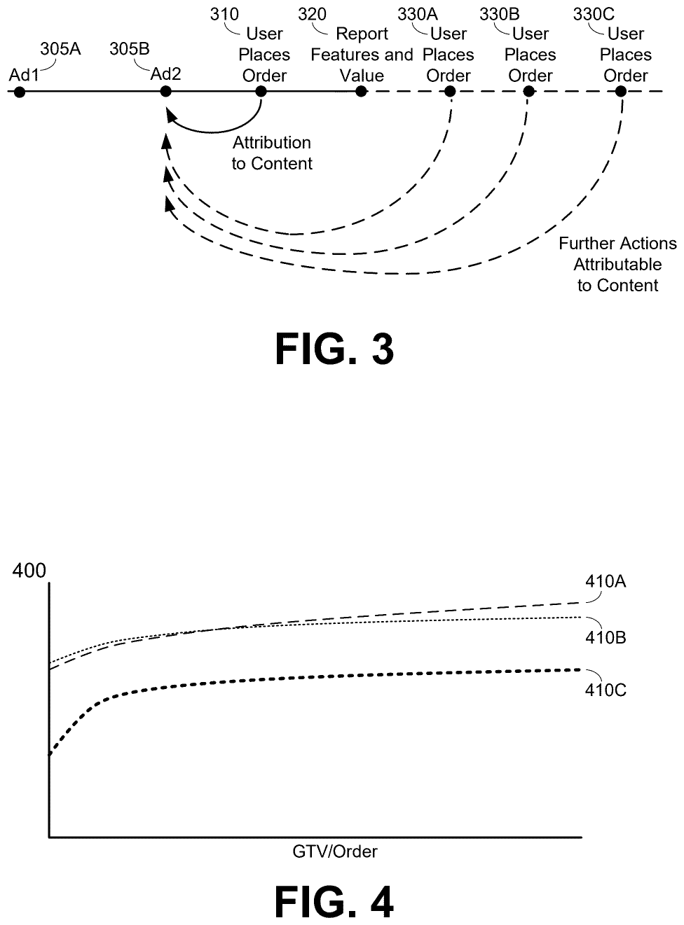

Advertisement content for the online concierge system 140 may be presented to users on various platforms and may take various forms, e.g., videos or gifs, savings or sales offers, personalized content on social media feeds, or the like. When users interact with the online concierge system 140 or place orders after having viewed advertisements, the value prediction module 250 associates the interaction or placed order with the advertisement that most likely caused the user to perform the action. In some embodiments, as further described in conjunction with FIG. 3, the value prediction module 250 identifies content for attribution value determination using a last-touch attribution model, wherein attribution for a conversion is given to a most recent impression, e.g., a most-recently clicked, viewed, or selected impression.

FIG. 3 is an example timeline illustrating one or more conversion events that may be attributed to a single impression, in accordance with one or more embodiments. In other embodiments, timelines may include more, fewer, or different events than those illustrated in FIG. 3. For example, timelines may include more or fewer impressions that occurred before an initial conversion, more or fewer impressions that occurred after an initial conversion, more or fewer orders that occurred before a given impression or after an initial conversion, or the like. Events may occur along various spans of time, e.g., within a few days, over the course of several months, or across a year or longer. As shown in FIG. 3, attribution is determined by the value prediction module 250. In other embodiments, attribution is determined, in part or in whole, by one or more other modules of the online concierge system 140 or third-party systems.

One or more ads or advertisement content 305A, B may be presented to a user over a period of time, and may or may not lead to the user interacting with the ad, e.g., clicking through to the online concierge system 140, adding particular items to an order, or placing an order. Often, users may not interact with every ad impression that is displayed to them. For example, users may see a first ad 305A that they do not interact with and a second ad 305B that causes them to later place an order 310 on the online concierge system 140, which is accordingly attributed to the second ad.

In some embodiments, the value prediction module 250 additionally identifies content for attribution value determination based on a set look-back window, which establishes a time limit in which an interaction with an impression occurs to be assigned attribution of a conversion. In various examples, the look-back window may be an hour, two hours, a day, or another set time window.

When a first order 310 is placed, the online concierge system 140 may generate a report 320, which may include features describing the user and a value for the ad 305B to which the order is attributed. The value for the ad may be used in downstream processes, such as in evaluating the ad content for inclusion in ad campaigns, by third-party or other bidding systems for future ad placement, or the like, and as such, should be as accurate as possible.

However, after the user places the first order 310, the user may subsequently place one or more other orders 330A, B, C in the future. Each future conversion may or may not be attributed to a new impression. In the example of FIG. 3, wherein no additional ad impression occurs, the subsequent orders 330 may be attributed to the same ad impression 305B as the initial conversion 310, as the subsequent orders are unlikely to have occurred without the ad impression and initial conversion. As such, as previously discussed, when the value prediction module 250 evaluates a value for the ad 305B, it is important to include predicted values for future orders 330 by the user that may be attributed to that ad.

Returning to FIG. 2, the value prediction module 250 calculates long-term incremental conversion values for impressions responsive to a conversion occurring. In some embodiments, the value prediction module 250 may calculate long-term incremental conversion values after a first or initial conversion for an impression. In other embodiments, the value prediction module 250 may calculate (or re-calculate) long-term incremental conversion values after each subsequent conversion for an impression.

Based on feature information describing the user, the value prediction module 250 determines a baseline curve that represents a long-term incremental conversion value for the user, which may be modified to reflect predicted behavior more accurately for a particular user.

In some embodiments, the value prediction module 250 may determine baseline curves based on experimental data describing historic user behavior on the online concierge system. For example, the value prediction module 250 may gather experimental data from an existing user database or subset of users of the online concierge system. The experimental data may include user features describing demographic, activity on the online concierge system 140, and any other information about users that may impact their behavior, frequency of orders, size of orders, value of an average order, and the like. Based on the experimental data, the value prediction module 250 may generate user types or groups in which users display similar behavioral patterns, and, for each user type, may generate a representative baseline curve.

In various embodiments, as shown in the example graph of FIG. 4, the online concierge system 140 may generate baseline curves 410A-C to different user types. For example, in some embodiments, the value prediction module 250 may classify users as “active,” “returning,” or “new,” in which active users (users having placed orders within a given timeframe) are expected to behave differently than returning users (users having placed orders in the past but none within the given timeframe) and new users (users that have not historically placed any orders before a current order). Accordingly, active users may be represented by a first baseline curve 410A, while returning users are represented by a second baseline curve 410B and new users are represented by a third baseline curve 410C. In other embodiments, the value prediction module 250 may use different user types, such as grouping users by location.

In the graph 400 of FIG. 4, the baseline curves 410 depict an expected gross transaction value per order (GTV/order) per month for each user group. In other examples, the baseline curves 410 may be represented using other metrics, such as, for example, value per order, expected orders per month, or any other relevant metrics that change based on user type.

Returning to FIG. 2, once a baseline curve is determined, the value prediction module 250 may use a computer trained model to determine one or more modifiers for the baseline curve. The one or more modifiers may be based on feature information describing a user, such that performing the modifications to the baseline curve generates a more personalized long-term conversion value for the given user. The computer model may be trained on user feature information and past behavior on the online concierge system 140 to predict how feature information correlates to future behavior by a user. User feature information may include various characteristics of users on the online concierge system 140, such as demographic information, location information or geographic trends, actions taken on the online concierge system, or the like.

The computer model may be trained by the value prediction module 250. In other embodiments, the computer model may be trained by one or more third-party systems or servers, such as by a bidding system or retailer system. The value prediction module 250 may use a single computer model for all user types and advertisement campaigns of the online concierge system 140. Alternately, computer models may be associated with particular user types or advertisement campaigns. The computer model may be stored in the data store 240 of the online concierge system 140, or may be stored or hosted remotely for access by the online concierge system 140. In various embodiments, the computer model may be a decision tree model, a random forest model, or a gradient boosting model.

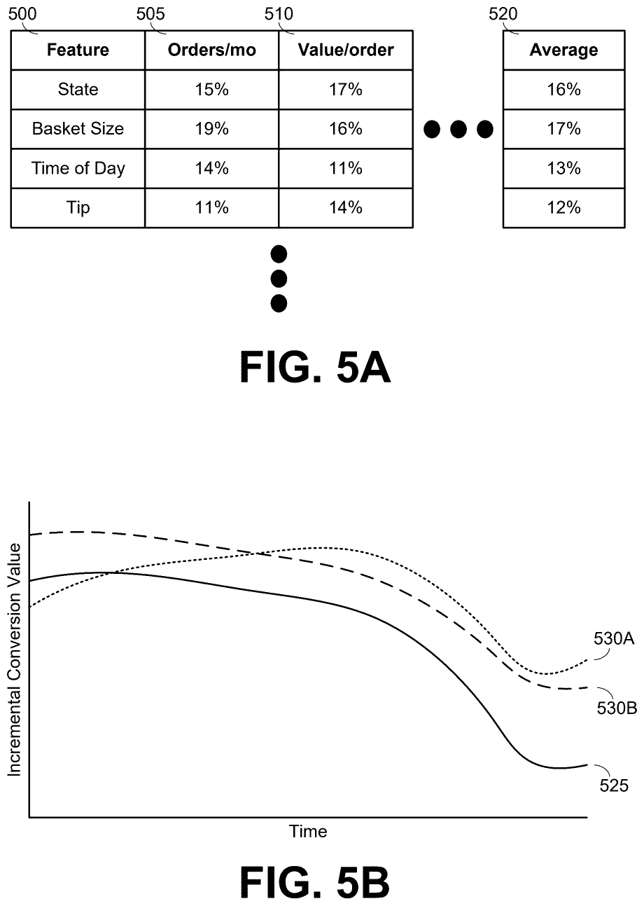

In some embodiments, the computer model is trained on feature information describing user behaviors, demographics, and other metrics. FIG. 5A is a chart illustrating example feature information which may be used by the computer model to determine percent relevance for the feature information to user behavior, and subsequently, to predict user behavior, in accordance with some embodiments. Because the user may have performed the conversion before reporting the value, the features used to predict modifiers to the baseline curve can include features related to the conversion itself, such as a basket (order) size, time of day the order was placed, tip, and additional characteristics of the order.

User feature information 500 may be collected by the online concierge system 140 responsive to users performing actions on the online concierge system. For example, the online concierge system 140 may gather information for user feature information describing ad impressions and subsequent conversions on the online concierge system, or may gather information for feature information describing orders placed by users. Further, user feature information 500 may include various demographic or behavioral information that may influence user behavior in future orders or transactions, and may be modified or changed over time, e.g., across multiple orders by the user, across time. Feature information 500 may include, for example, a state or location of a user, basket size of an order, a time of day an order was placed, a time of day an order was delivered, a tip added to an order, a duration of time spent on the online concierge system before an order being placed, brands associated with items in the placed order, a frequency of orders being placed, and additional or other features.

Each of the feature information may correlate to future user behavior, such that a set of user feature information may be used to predict future user behavior on the online concierge system 140. In the example chart of FIG. 5A, the value prediction module 250 may determine a relevance of each user feature to the modifiers, such as orders/month 505 and value/order 510 for a user. In other embodiments, the online concierge system 140 may additionally determine a percent relevance of each user feature to one or more other metrics, such as gross transaction value (GTV)/order. The average 520 percent relevance for each user feature may be determined based on a mean value of percent relevance for each metric used by the online concierge system 140.

Once trained, the value prediction module 250 may use output from the computer model to determine a set of one or more modifiers to a baseline curve to determine a modified incremental conversion value for users.

FIG. 5B is a graph illustrating modifiers applied to a baseline curve, in accordance with one or more embodiments. The example graph shows a baseline curve 525 representing a predicted incremental conversion value for a user over time. The baseline curve 525 may be identified by the value prediction module 250 based on, for example, a user type or group associated with the user, as described previously in conjunction with FIG. 4.

Based on modifiers determined for the user, e.g., output by the computer model, the value prediction module 250 modifies the baseline curve 525 to generate a modified curve 530 for the user. In the graph illustrated in FIG. 5B, the modified curves 530A, 530B are examples of possible modified curves from the baseline curve 525 for a user. Because the modifiers used to generate the modified curves 530 are determined based on feature information specific to a given user, the modified curves are also specific to the user's predicted behavior.

The modifiers may impact the baseline curve 525 in various ways. For example, the modifiers may reflect predicted behavior across different aspects of interaction with the online concierge system (e.g., order frequency, order value, and so forth), which may be reflected by different transformations or translations of the baseline curve 525. Additionally, these modifiers may impact the baseline curve 525 in whole or in part.

Based on the modified curves 530, the value prediction module 250 may determine a modified long-term incremental value for the user. In some embodiments, the modified long-term incremental value may be determined, for example, by calculating an integral of the modified curve 530. In other embodiments, the modified long-term incremental value may be determined by other calculations based on the modified curve 530. For example, the modified curve may indicate a frequency and value of future interactions, such that the individual expected interactions and expected values may be converted to a present value. The modified long-term incremental conversion value, in some examples, may be a single value representative of a total expected value based on predicted user behavior, e.g., a total predicted spend by the user attributable to a given impression. In other examples, the modified long-term incremental conversion value may be a function (e.g., value over time).

Once determined, the value prediction module 250 may provide the modified long-term incremental conversion value to one or more downstream systems or processes. In some embodiments, the value prediction module 250 provides the modified long-term incremental conversion value to a bidding system. The bidding system may use the modified long-term incremental conversion value to determine appropriate expenditures for advertisement campaigns, or may compare the modified long-term incremental conversion values of different advertisement campaigns to, for example, select to preferentially bid on advertisement campaigns with higher modified long-term incremental conversion values.

In other embodiments, the value prediction module 250 provides the modified long-term incremental conversion value to an administrator or user of the online concierge system 140 or of a third-party system. The modified long-term incremental conversion value may be used in various downstream processes, such as internal comparisons between advertisement campaigns for the online concierge system 140, metrics on user feature information and predicted user behavior, and the like.

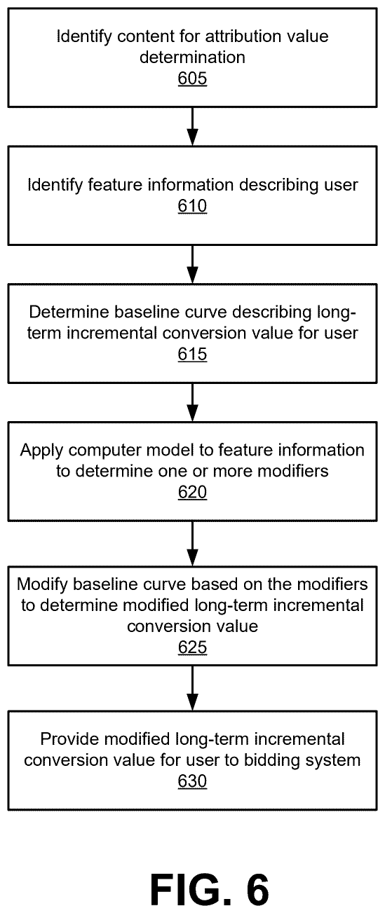

FIG. 6 is a flowchart for a method of predicting user behavior based on a conversion event, in accordance with one or more embodiments. Alternative embodiments may include more, fewer, or different steps from those illustrated in FIG. 6, and the steps may be performed in a different order from that illustrated in FIG. 6. These steps may be performed by an online concierge system (e.g., online concierge system 140). Additionally, each of these steps may be performed automatically by the online concierge system without human intervention.

Users of the online concierge system 140 may view and interact with advertisement content on the online concierge system or other third-party systems. When a conversion event occurs, the online concierge system 140 identifies 605 advertisement content for attribution value determination for the conversion. In some embodiments, the online concierge system 140 uses a last-touch attribution model, wherein attribution for a conversion is given to a most recently “touched” impression, e.g., a most-recently clicked, viewed, or selected impression. In some embodiments, the online concierge system 140 additionally or instead considers advertisement content viewed or selected by the user within a set timeframe before the conversion.

The online concierge system 140 identifies 610 feature information describing the user. In some embodiments, the online concierge system 140 may continually or intermittently identify feature information describing the user (e.g., responsive to actions taken by the user on the online concierge system, at set time intervals, etc.). In other embodiments, the online concierge system 140 may identify feature information describing the user responsive to a conversion event taking place. Feature information may include information about orders placed by a user, including, for example, a number of items purchased, a frequency of orders placed, a time of day at which an order is placed, a location to which an order is placed, a total cost of a placed order, an average cost of items in a placed order, or other information describing the order and/or items within the order. Additionally, feature information may include information about the user, including, for example, a location of the user, demographic information about the user, or the like.

The online concierge system 140 may classify a user within one or more user types or groups based on feature information, wherein each user type is associated with similar behavior on the online concierge system. The user types may be, for example, based on activity on the online concierge system 140, where consistently “active” users may be expected to behave differently than “returning” users or “new users. Based on the user types or other feature information, the online concierge system 140 determines 615 a baseline curve describing long-term incremental conversion value for the user. In some embodiments, baseline curves may be determined based on experimental data describing historic user behavior on the online concierge system 140.

The online concierge system 140 applies 620 a trained computer model to the feature information to determine one or more modifiers. In some embodiments, the computer model is trained on user feature information to output modifiers representative of which features are relevant to user behavior and how the relevant features correlate to predicted future behavior by the users. The online concierge system 140 modifies 625 the baseline curve based on the modifiers to determine a modified long-term incremental conversion value for the user. Modifying the baseline curve may include one or more of transforming or translating the baseline curve, in part or in whole. Additionally, determining the modified long-term incremental conversion value for the user may include one or more additional operations or processes, such as calculating an integral of the modified curve, identifying one or more points along the modified curve, or the like.

Once determined, the online concierge system 140 provides 630 the modified long-term incremental conversion value for the user for use in downstream analyses or processes. In some embodiments, the online concierge system 140 may provide the modified long-term incremental conversion value to a bidding system. The modified long-term incremental conversion value may be used by the bidding system when selecting between ad campaigns associated with the different values, or when determining appropriate prices for placing advertisement content for later impressions. In other embodiments, the online concierge system 140 may provide the modified long-term incremental conversion value to one or more administrators or users of the online concierge system or of a third-party system for use in various downstream processes, such as internal comparisons or metrics.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example; comparing an output of the machine-learning model to the label associated with the training example; and updating weights associated for the machine-learning model through a back-propagation process. The weights may be stored on one or more computer-readable media and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
attributing a conversion event by a user of an online system to one or more previous impressions by the user of content provided to the user by the online system;
identifying feature information describing the user;
generating a baseline curve describing a long-term incremental conversion value for the user;
applying a computer model to the feature information describing the user to generate one or more modifiers, wherein the computer model is trained based on a set of training examples that describe previous conversions and long-term conversions associated with the previous conversions;
modifying the baseline curve based on the modifiers to generate a modified long-term incremental conversion value for the user; and
outputting the modified long-term incremental conversion value for the user.

2. The method of claim 1, wherein generating the baseline curve comprises:
generating a customer type describing the user, the customer type based at least in part on conversion history of the user; and
selecting the baseline curve associated with the customer type.

3. The method of claim 1, wherein attributing the conversion event comprises:
identifying information describing a conversion by the user of the online system; and
identifying content viewed by the user before the conversion.

4. The method of claim 1, wherein modifying the baseline curve based on the modifiers comprises modifying one or more of: order frequency, order value, order or delivery type, basket size, or order time.

5. The method of claim 1, further comprising:
providing the modified long-term incremental conversion value for the user to a bidding system.

6. The method of claim 5, further comprising:
receiving an order from the user;
identifying updated feature information describing the user;
applying the computer model to the updated feature information to generate one or more updated modifiers;
modifying the baseline curve based on the updated modifiers to generate a second modified long-term incremental conversion value for the user; and
providing the second modified long-term incremental conversion value for the user to the bidding system.

7. The method of claim 1, further comprising:
providing the modified long-term incremental conversion value for the user to one or more of: an administrator of the online system or an administrator of a third-party system.

8. The method of claim 1, wherein the computer model is one or more of: a decision tree model, a random forest model, or a gradient boosting model.

9. A computer program product comprising a non-transitory computer-readable storage medium having instructions encoded thereon that, when executed by a processor, cause the processor to perform steps comprising:
attributing a conversion event by a user of an online system to one or more previous impressions by the user of content provided to the user by the online system;
identifying feature information describing the user;
generating a baseline curve describing a long-term incremental conversion value for the user;
applying a computer model to the feature information describing the user to generate one or more modifiers, wherein the computer model is trained based on a set of training examples that describe previous conversions and long-term conversions associated with the previous conversions;
modifying the baseline curve based on the modifiers to generate a modified long-term incremental conversion value for the user; and
outputting the modified long-term incremental conversion value for the user.

10. The computer program product of claim 9, wherein generating the baseline curve comprises:
generating a customer type describing the user, the customer type based at least in part on conversion history of the user; and
selecting the baseline curve associated with the customer type.

11. The computer program product of claim 9, wherein attributing the conversion event comprises:
identifying information describing a conversion by the user of the online system; and
identifying content viewed by the user before the conversion.

12. The computer program product of claim 9, wherein modifying the baseline curve based on the modifiers comprises modifying one or more of: order frequency, order value, order or delivery type, basket size, or order time.

13. The computer program product of claim 9, wherein the instructions further cause the processor to perform steps comprising:
providing the modified long-term incremental conversion value for the user to a bidding system.

14. The computer program product of claim 13, wherein the instructions further cause the processor to perform steps comprising:
receiving an order from the user;
identifying updated feature information describing the user;
applying the computer model to the updated feature information to generate one or more updated modifiers;
modifying the baseline curve based on the updated modifiers to generate a second modified long-term incremental conversion value for the user; and
providing the second modified long-term incremental conversion value for the user to the bidding system.

15. The computer program product of claim 9, wherein the instructions further cause the processor to perform steps comprising:
providing the modified long-term incremental conversion value for the user to one or more of: an administrator of the online system or an administrator of a third-party system.

16. The computer program product of claim 9, wherein the computer model is one or more of: a decision tree model, a random forest model, or a gradient boosting model.

17. A computer system comprising:
a processor that executes instructions; and
a non-transitory computer-readable storage medium having instructions executable by the processor for:
attributing a conversion event by a user of an online system to one or more previous impressions by the user of content provided to the user by the online system;
identifying feature information describing the user;
generating a baseline curve describing a long-term incremental conversion value for the user;
applying a computer model to the feature information describing the user to generate one or more modifiers, wherein the computer model is trained based on a set of training examples that describe previous conversions and long-term conversions associated with the previous conversions;
modifying the baseline curve based on the modifiers to generate a modified long-term incremental conversion value for the user; and
outputting the modified long-term incremental conversion value for the user.

18. The computer system of claim 17, wherein generating the baseline curve comprises:
generating a customer type describing the user, the customer type based at least in part on conversion history of the user; and
selecting the baseline curve associated with the customer type.

19. The computer system of claim 17, wherein attributing the conversion event comprises:
identifying information describing a conversion by the user of the online system; and
identifying content viewed by the user before the conversion.

20. The computer system of claim 17, wherein modifying the baseline curve based on the modifiers comprises modifying one or more of: order frequency, order value, order or delivery type, basket size, or order time.
